(19) United States
(12) Patent Application Publication
(10) Pub. No.: US 2025/0320581 A1
(43) Pub. Date: Oct. 16, 2025

(54) FILTERING BRINE STREAMS FROM DIRECT LITHIUM EXTRACTION UNITS USING FLOW RATES ADJUSTED BASED ON ELECTRICAL CONDUCTIVITY

(71) Applicant: ExxonMobil Technology and Engineering Company, Spring, TX (US)

(72) Inventor: Sean A. MASON, Houston, TX (US)

(21) Appl. No.: 19/095,542

(22) Filed: Mar. 31, 2025

Related U.S. Application Data
(60) Provisional application No. 63/634,164, filed on Apr. 15, 2024.

(51) Int. Cl. C22B 26/12; C22B 3/02; C22B 3/22; C22B 3/44

(52) U.S. Cl. CPC C22B 26/12; C22B 3/02; C22B 3/22; C22B 3/44

(57) ABSTRACT

An apparatus and method for enabling lithium extraction. An exemplary embodiment provides an apparatus for brine filtration. The apparatus includes a conductivity meter to receive a pretreated brine stream and measure a conductivity of the pretreated brine stream. The apparatus further includes a controller to adjust a flux rate of the pretreated brine stream in response to detecting a change in the conductivity of the pretreated brine stream.

### CROSS-REFERENCE TO RELATED APPLICATION

This application claims priority to and the benefit of U.S. Provisional Application No. 63/634,164, entitled “FILTERING BRINE STREAMS FROM DIRECT LITHIUM EXTRACTION UNITS USING FLOW RATES ADJUSTED BASED ON ELECTRICAL CONDUCTIVITY,” having a filing date of Apr. 15, 2024, the disclosure of which is incorporated herein by reference in its entirety.

### FIELD

The present techniques generally relate to extraction of metals from brines. More specifically, the present techniques are directed towards methods and apparatuses for preparing brine for direct lithium extraction (DLE).

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Metals such as lithium are extracted from different sources for use in various products, including batteries. For example, lithium may take the form of lithium compounds, such as lithium carbonate or lithium hydroxide. Technical grade lithium carbonate is approximately 99% lithium carbonate by weight. The purity standard for battery-grade lithium carbonate may exceed 99.5%.

One available source of lithium is from brines containing lithium among other metals. Such brines may be obtained from various sources. A number of brine sources exist naturally. For example, brine sources include brine deposits like the Salar de Atacama in Chile, Silver Peak Nevada, Salar de Uyuni in Bolivia, the Salar de Hombre Muerte in Argentina, or the Smackover Formation in Arkansas, among other natural deposits.

One currently used method of obtaining metals such as lithium from brines involves the use of solar evaporation ponds. In solar evaporation ponds, evaporation is used to enrich the brine and thus increase the concentration of metals in the brine. Chemical treatments may then be used to purify the brine and reduce impurities. The purified brine may then be converted into a lithium compound via a conversion process. For example, the conversion process may involve the use of a crystallization process to produce the lithium compound. The crystallizers may require a feed brine input with lithium concentrations in excess of about 60,000 parts per million (ppm) and impurity concentration of less than 500 ppm. By contrast, the water chemistry from commercial brine sources may tend to have lithium concentrations on the order of 100-1,000 ppm and a total dissolved solid concentration exceeding 50,000 ppm. Solar evaporation may thus be used to increase lithium concentrations, with chemical treatments to reduce impurities.

However, the usage of solar evaporation ponds may be restricted to use in arid environments that tend to be at high altitudes and remote. Moreover, production time using solar evaporation ponds is long, potentially taking up to 18 months to reach adequate concentrations of lithium or other metals. In addition, solar evaporation has a low selectivity to lithium that requires higher quality brines while recovering less than 50% of lithium. Finally, solar evaporation methods have large land requirements as well as a need for fresh water in arid environments. An improved process of lithium production is desirable.

### SUMMARY

An exemplary embodiment provides an apparatus for brine filtration. The apparatus includes a conductivity meter to receive a pretreated brine stream and measure a conductivity of the pretreated brine stream. The apparatus includes a controller to adjust a flux rate of the pretreated brine stream in response to detecting a change in the conductivity of the pretreated brine stream.

Another exemplary embodiment provides a method of filtering a brine composition. The method includes receiving a pretreated brine stream. The method includes calculating, via a conductivity meter, a conductivity of the pretreated brine stream. The method includes, in response to detecting a change in the conductivity of the pretreated brine stream, adjusting a flux rate of the pretreated brine stream.

These and other features and attributes of the disclosed embodiments of the present techniques and their advantageous applications and/or uses will be apparent from the detailed description that follows.

### BRIEF DESCRIPTION OF THE DRAWINGS

The advantages of the present techniques are better understood by referring to the following detailed description and the attached drawings, in which:

FIG. 1 is an illustration of an apparatus for the extraction of lithium from a lithium-containing brine, according to embodiments herein;

FIG. 2 is an illustration of an apparatus for the removal of ions from a brine stream, according to an embodiment;

FIG. 3 is a schematic diagram depicting an example nanofiltration control schema, according to an embodiment; and

FIG. 4 is a process flow diagram of a method for filtering ions from a brine stream, according to another embodiment.

### DETAILED DESCRIPTION

As used herein, the following terms shall have the following meanings.

As used herein, “brine” or “brine solution” refers to any aqueous solution that contains a substantial amount of dissolved metals, such as alkali and/or alkaline earth metal salt(s) in water, wherein the concentration of salts can vary from trace amounts up to the point of saturation. Generally, brines suitable for the methods described herein are aqueous solutions that may include alkali or alkaline earth metal chlorides, bromides, sulfates, hydroxides, nitrates, and the like, as well as natural brines. In certain brines, other metals like lead, manganese, and zinc may be present. Exemplary elements present in the brines can include sodium, potassium, calcium, magnesium, lithium, strontium, barium, iron, boron, silica, manganese, chlorine, zinc, aluminum, antimony, chromium, cobalt, copper, lead, arsenic, mercury, molybdenum, nickel, silver, thallium, vanadium, and fluorine, although it is understood that other elements and compounds may also be present. Brines can be obtained from natural sources, such as Chilean brines or Salton Sea brines, geothermal brines, Smackover brines, sea water, mineral brines (e.g., lithium chloride or potassium chloride brines), alkali metal salt brines, and industrial brines, for example, industrial brines recovered from ore leaching, mineral dressing, and the like. Brines include continental brine deposits, geothermal brines, and waste or byproduct streams from industrial processes, synthetic brines, and other brines resulting from oil and gas production. In some embodiments, the brines are brines from which energy has already been extracted. For instance, brines used herein include brines from which a power plant has already extracted energy through methods such as flashing.

The term “deep subsurface brine” refers to a saline solution that has circulated through rocks deep in reservoirs such as those found in East Texas, North Dakota, and Arkansas in the United States, and in Alberta, Canada.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

The term “geothermal brine” refers to a saline solution that has circulated through the crustal rocks in areas of high heat flow and has become enriched in substances leached from those rocks. Geothermal brines, such as those found in the Salton Sea geothermal fields, can include many dissolved metal salts, including alkali, alkaline earth, and transition metal salts.

The term “concentrated” in reference to a brine (e.g., “concentrated brine” or “concentrated deep subsurface brine”) refers to brines that have reduced water content compared to the original brine. The reduced water content brine may be subsequently diluted post-concentration to prevent salt precipitation. In some embodiments, concentrated brines can result from various stages used during a DLE process.

The term “lithium salts” can include lithium nitrates, lithium sulfates, lithium bicarbonate, lithium halides (particularly chlorides and bromides), and acid salts. For example, the Salton Sea brines have lithium chlorides.

As used herein, “lithium selectivity” refers to the ability of a sorbent to preferentially extract lithium while rejecting impurities.

As used herein, “loading capacity” refers to the extracted lithium per unit of sorbent.

As used herein, precipitates of iron oxides include iron oxides, iron hydroxides, iron oxide-hydroxides and iron oxyhydroxides.

The term “Smackover brine” refers to a type of mineral-rich water that is found in the Smackover Formation, a geological layer that formed during the Jurassic period and spans across several states in the southern United States. Smackover brines are considered a resource for lithium and bromine in particular. Smackover brines may be extracted from the Smackover Formation by pumping them from wells that reach the limestone aquifer. The brines are then processed to separate the lithium and bromine from the water and other minerals.

The term “treated” in reference to a brine (e.g., “treated brine”) refers to brines that have been processed such that the concentration of at least one metal or elemental component has been reduced in the brine. For instance, a brine in which the concentration of silica and iron has been reduced is a treated brine, also referred to as reduced silica and iron brine.

The term “lithium salts” can include lithium nitrates, lithium sulfates, lithium bicarbonate, lithium halides (particularly chlorides and bromides), and acid salts. For example, the Salton Sea brines have lithium chlorides.

As used herein, “lithium selectivity” refers to the ability of a sorbent to preferentially extract lithium while rejecting impurities.

As used herein, “loading capacity” refers to the extracted lithium per unit of sorbent.

As used herein, precipitates of iron oxides include iron oxides, iron hydroxides, iron oxide-hydroxides and iron oxyhydroxides.

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

Direct lithium extraction (DLE) is a selective lithium extraction process that enables selective recovery of lithium from a complex mineral mix of brine. DLE has lower recovery times in the order of hours or days rather than months. Moreover, DLE enables greater than 90% recovery of lithium from brines. In addition, DLE utilizes less land area and can be conveniently deployed anywhere. The present techniques relate to preparing brine so that it is suitable for efficient processing via DLE. The present techniques also generally relate to compositions of treated brine having reduced concentrations of hydrogen sulfur (H2S). The present technological innovation generally relates to compositions for preventing sorbent poisoning and pipe corrosion. These techniques generally relates to treated brine compositions with reduced concentrations of H2S that can also be used for recovery of metals, including lithium, manganese, rubidium, cesium, and potassium.

DLE can be integrated with other technologies for production of lithium product. For example, such technologies may include a precipitator, reverse osmosis, filtration, multi-effect evaporator, and crystallizer, or any combination thereof. Sorption-based techniques are also used for recovery of lithium. For example, a lithium-aluminum-layered double hydroxide chloride sorbent (LAH or AlOH) is sometimes used. DLE today is typically used on salt lake assets. DLE salt lake brine producers make use of evaporation ponds to assist with the pre-treatment, impurity removal, and dewatering, and do not re-inject the water back into the reservoir. However, the water chemistries may have much less impurities than deep subsurface brines because such DLE producers either produce the lithium from the tailings of other brine operations or they target resources for their low impurity concentrations. For example, some producers process their lithium from the brine tailings of their potash operations, which significantly cleans up the water. Some other DLE operations have specifically targeted salt lakes with water chemistries that are more suitable for DLE.

Thus, a different DLE flow may be used on deep subsurface brines as compared to DLE operations with ponds. In particular, the need for impurity removal and dewatering steps may be greater and thus addressed solely with industrial facilities. The key cost drivers may thus be determined by the cost associated with each processing step (i.e. pre-treatment, the DLE step, impurities removal, and dewatering to enhance lithium concentration), and can be categorized as robustness to water chemistry, lithium selectivity, and loading capacity. The three of these processing steps—pre-treatment, impurity removal, and dewatering—are all tied directly to the DLE process, and therefore, the costs are not necessarily independent of one another, as described in greater detail below. Generally, with respect to robustness to water chemistry, the pre-treatment steps prior to DLE must process the largest volume up front, such as chemical treatment or filtration, to remove impurities that cause unsafe operations, scaling issues, or deteriorate sorbent performance.

DLE technology robustness against a wide range of water chemistries can minimize the need for pre-treatment and its cost. With respect to lithium selectivity and loading capacity, the lithium concentrated stream after DLE may still require further refinement to produce a battery grade product, thus necessitating additional post-treatment. The amount of impurities remaining after DLE is determined by the lithium selectivity, while the lithium concentration post DLE is determined by the loading capacity of the sorbent. Post DLE processes are designed to remove residual impurities, boost lithium concentration, and convert to high purity lithium carbonate or lithium hydroxide, and therefore, post-treatment processes will endure more cost for larger quantities of impurities and lower lithium concentrations post-DLE. For example, post DLE processes may include chemical treatments, filtration, dewatering, and crystallization.

While these cost drivers are described independently, they can be highly correlated. For example, lithium selectivity, loading capacity, and robustness may all be tied to the same or correlated physical mechanisms. Another additional complexity is that the mechanisms that enable the use of a particular material in the DLE step to selectively extract lithium rely on thermodynamically favored conditions, and different source brines will be unique in their make-up, and even small differences in water chemistry may alter the thermodynamics in a manner that also influences lithium selectivity and loading capacity. Therefore, these key cost drivers cannot be considered independent of one another or in the absence of the water chemistry under consideration. Therefore, DLE may work best if engineered for a specific lithium deposit. Unlike pond-assisted DLE, the spent brine may also need to be re-injected or cleaned prior to surface discharge.

DLE processes can have up to 98-99% rejection of ions, such as calcium or magnesium, among other ions. In some examples, a nanofilter can be used in a lithium plant to further remove calcium or magnesium. For example, multiple nanofilters can be used in series, with a more concentrated stream going to the N, N+1, etc., nanofilter. As the train of filters increases, the ionic concentration of the stream increases. However, from the first to the last nanofilter, the concentration of ions may increase by a factor of 2-10 as permeate water is continually removed from the stream. Therefore, to maintain a high operating flux necessary to prevent scaling and optimize performance, the pump pressure may sometimes be increased to overcome the increased osmotic pressure.

In addition, nanofiltration also relies on an optimal flux rate to ensure that there is optimal lithium passage. If the flux is too high, there will not be good separation of ions, but if the flux is too low, scaling can occur. As the osmotic pressure of the stream increases, without sufficient pump pressure, there may reduced ionic separation.

Moreover, although DLE can remove 98-99% of ions, the exact amount of removed ions can matter quite a bit for the nanofilter downstream. This is because the flip of the number is that nanofiltration can receive 1-2% of the incoming ions from DLE. For example, 99% rejection of a 10,000 ppm stream is 100 ppm going to the nanofilters, while 98% rejection is 200 ppm going to the nanofilters. This is a range of 100%, meaning before any permeate is drawn off, the ions into the nanofilter unit could already be double from what the amount in the previous batch was. If this occurs, then the pump into the nanofilter unit may need to greatly increase pressure to not only maintain flux in the first unit, but also every downstream nanofilter that will see a higher concentration as well. Existing methods may not control ion passage out of the DLE unit into the first pre-treatment unit.

Some methods enable the determination of the ionic composition of a stream. For example, ionic conductivity plasma (ICP) optimal emission spectroscopy (OES) may be used to take a sample of the stream, process the sample, and output a resulting composition of ions for the sample within the range of one to eight hours later. However, such methods may not be able to determine the ionic composition of the stream in real time. Thus, the composition of the stream may change within the time taken to determine the exact composition.

In addition, although some methods may use electrical conductivity meters for lithium processes, the integration between DLE and concentration, refinement, and conversion (CRC) is sparse. Therefore a system that integrates DLE with CRC in a manner that optimizes lithium extraction is desired.

Accordingly, embodiments described herein enable more efficient extraction of lithium and other metals from deep subsurface brines, among other sources of brine. In one embodiment, a filtration process is described with improved pre-treatment of DLE output streams for improved extraction of lithium. The embodiments include the use of an electrical conductivity meter and a variable flow device to change the pump pressure into a nanofiltration unit depending on the conductivity. Higher electrical conductivity may correspond to more ions in a stream, resulting in the need for higher pump pressure to overcome an osmotic pressure. In some embodiments, the electrical conductivity is used to determine whether the DLE sorbent is failing in response to detecting not enough rejection, or used to make downstream improvements, such as operating at higher fluxes. Thus, in some embodiments, the electrical conductivity is not just used to increase pressure to overcome osmotic pressure, but also for increasing permeate flux. The embodiments may be used in lithium plants, where the process upstream of a nanofilter can have various ionic rejections. In lieu of a reactive flow meter on the nanofilter outlet, a pre-emptive conductivity meter on the inlet can further optimize performance of the lithium plants.

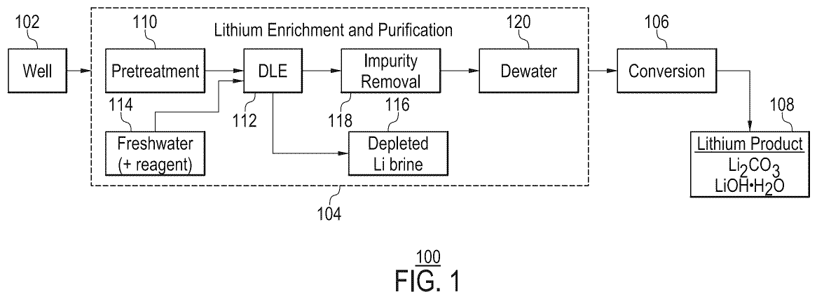

Referring now to FIG. 1, an apparatus 100 for the removal of lithium from a lithium containing brine is provided. A brine containing lithium and other metals is provided via a well 102. The brine received from the well 102 may thus be a deep subsurface brine. A lithium enrichment and purification process 104 may then generally purify the brine to produce a purified brine that is sent to a conversion process 106, which converts the brine into a lithium product 108. For example, the lithium product 108 may be lithium carbonate (Li₂CO₃) or lithium hydroxide monohydrate (LiOH H₂O).

As shown in FIG. 1, the lithium enrichment and purification process 104 includes a pre-treatment process 110. Pre-treated brine from the pre-treatment process 110 is then processed via a DLE process 112. The DLE process 112 can increase both the ratio of lithium to impurities and the lithium concentration and, regardless of the technique and materials used, this is accomplished by swapping lithium out of the source brine into a fresh water stream 114. In various examples, depending on the techniques applied, additional reagents may also be added to the fresh water stream 114. For example, such reagents may include sodium sulfate (Na2SO4), sodium hydroxide (NaOH), sodium carbonate (Na2CO3), hydrochloric acid (HCl), or sulfuric acid (H2SO4), among other reagents. Each of the steps before and after DLE process 112 are thus tied to the DLE process 112 and the materials used to promote this swap. If impurities in the water would harm the DLE process 112, then these impurities are first removed and this is done in the pre-treatment process 110.

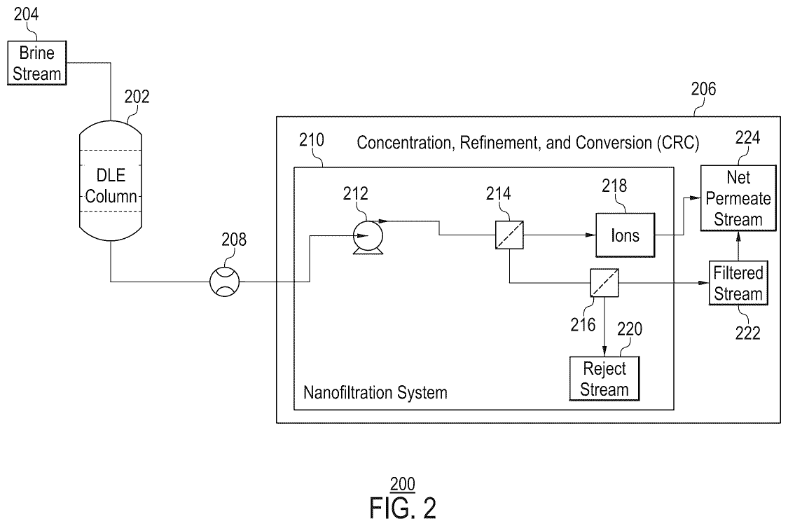

The results of the DLE process 112 is a depleted lithium brine 116 that and a lithium rich water stream that is sent to an impurity removal process 118. For example, the impurity removal process 118 may include the use of various technologies, such as the nanofiltration system 210 among other components of the concentration, refinement, and conversion (CRC) system 206 described in FIG. 2 below. In various embodiments, the depleted lithium brine 116 may be deposited back into the well 102. In some embodiments, the depleted lithium brine 116 may be additionally treated before being injected into the well 102. In various embodiments, the spent brine is collected from the DLE process 112 and disposed either onto the surface or re-injected into the subsurface reservoir. For surface disposal, regulatory approval may be required, and depending on location, large quantities of impurities may need to be removed. For reinjection, retention of impurities are required to ensure compatibility with the original subsurface brine. In some embodiments, if too many components are depleted from or added to the spent brine relating to the pre-treatment and DLE processing step, then the spent brine may need to be rebalanced to be compatible with the subsurface brine. Otherwise, an incompatible brine may present a risk of excessive scaling and improper pressure maintenance of the reservoir or well 102.

The impurity removal process 118 removes any remaining impurities in the lithium water stream. For example, there may be some amount of impurities that remain with the lithium after the DLE process 112 because no material and technique that can perfectly select for lithium may exist. Therefore, the post-DLE impurity removal process 118 may be used to remove any such remaining impurities. In various examples, such remaining impurities may include calcium (Ca), boron (B), magnesium (Mg), sodium (Na), strontium (Sr), silicon (Si), zinc (Zn), iron (Fe), potassium (K), argon (Ar), lead (Pb), nickel (Ni), or copper (Cu), among other remaining impurities.

The dewater process 120 receives purified lithium solution from the impurity removal process 118. For example, after the DLE process 112, the lithium concentration may still be less than an example target concentration of 30,000 ppm. In various embodiments, the target concentration for lithium is within the range of 30,000 to 100,000 ppm. Therefore, the dewatering process 120 may be applied to remove the water from the purified lithium solution.

The conversion process 106 then receives purified and concentration lithium solution from the dewatering process 120 of the lithium enrichment and purification process 104. In some embodiments, once all the above enrichment and purification steps are completed, the lithium enriched brine is fed to the conversion process 106 to produce a saleable battery grade lithium product. For example, the conversion process 106 may include the use of a crystallizer that can generate lithium products such as lithium carbonate, lithium hydroxide monohydrate, or lithium phosphate, among other lithium products.

In various embodiments, there thus may be fresh water, chemical, electrical, and sorbent manufacturing requirements to operate a DLE facility using the apparatus 100. In some embodiments, if the apparatus 100 is constructed in a remote location, then delivery of chemicals or sorbents may be unreliable and/or cost of transport of any such chemicals or sorbents may be prohibitive. Therefore, in some embodiments, chemicals and sorbents may also be produced on-site.

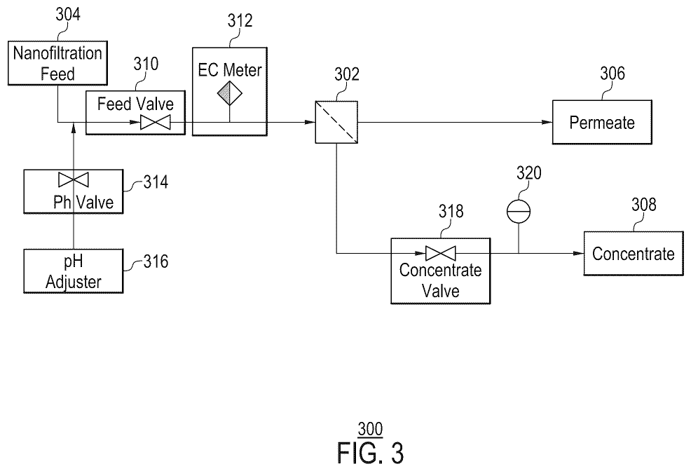

FIG. 2 is an illustration of an apparatus 200 for the removal of ions from a brine stream according to an embodiment. The apparatus 200 includes a direct lithium extraction (DLE) column 202. The DLE column 202 is shown receiving a brine stream 204. For example, the brine stream 204 may be a stream of brine from a well. In some examples, the brine stream 204 may have been pretreated using any suitable techniques, such as those described in FIG. 1. In various examples, the output stream of brine from the DLE column 202 may be a concentrated stream. The apparatus 200 further includes a concentration, refinement, and conversion (CRC) system 206 fluidically coupled to the DLE column 202. The apparatus 200 includes an electrical conductivity meter 208 located between the DLE column 202 and the CRC system 206. The electrical conductivity meter 208 can measure the conductivity of the stream passing between the DLE column 202 and the CRC system 206. The CRC system 206 includes a nanofiltration system 210. The nanofiltration system 210 includes a controller 212. The nanofiltration system 210 further includes a first nanofilter 214 fluidically coupled to the controller 212. For example, the controller 212 may be coupled to a flow rate adjuster and a pH adjuster to control a flux rate adjustment, pH adjustment, or both, in response to detecting a change in conductivity in the pretreated stream. In various examples, the flow rate adjuster may be include a valve that is adjusted to open or close based on the readings of the conductivity meter. In this manner, the permeate flow rate may be adjusted to indirectly control the flux rate. In various examples, the pH adjuster may include a valve that can be adjusted on an acid or caustic tank inlet. An example control schema depicting both flow rate and pH control is described with respect to FIG. 3. The nanofiltration system 210 also further includes a second nanofilter 216 fluidically coupled to the first nanofilter 214. The first nanofilter 214 is shown generating a first output stream of ions 218. The second nanofilter is shown generating a second output reject stream 220 of ions suspended in water and a filtered stream 222. For example, the filtered stream 222 may be further processed in the CRC system 206 to generate a purified lithium product. In some embodiments, the stream of ions 218 and the filtered stream 222 is combined as a net permeate stream 224. In these embodiments, the combined net permeate stream is further processed in the CRC system 206 to generate a purified lithium product. For example, this further processing may include dewatering and conversion, as described in FIG. 1 above.

In various embodiments, the CRC system 206 may receive an output stream from the DLE column 202 and output a lithium product. The nanofiltration system 210 may be the first processing performed on the output stream by the CRC system 206. In various embodiments, the pretreated stream from the DLE column 202 may be processed through any number of nanofilters 214, 216 to remove any variety of ions. For example, the ion stream 218 and reject stream 220 may include calcium, magnesium, or any other ions present in the stream that may need to be removed. For example, additional anions to be removed include fluoride, bromide, chloride, sulfate, carbonate, and hydroxide, among others. In various examples, each of the nanofilters 214, 216 may include nano-sized holes through which the brine is passed at a certain flux rate and a certain pH, both of which may depend on the composition of the brine stream. For example, a stream having high amounts of boron may be processed with a different pH than a stream having low amounts of boron. Similarly, a stream with high amounts of impurities may be processed at a higher flux in order prevent scaling. However, there may be a tradeoff between how much lithium is recovered by the apparatus 200 and how much ions are rejected by the nanofiltration system 210. Therefore, the flux rate may also be kept lower in order to enable more lithium to be efficiently extracted.

As described above, calculating the precise composition of the stream output from the DLE column 202 may not be possible in real time. Therefore, the apparatus 200 includes a conductivity meter 208 to estimate the general composition of the stream in real time. In particular, the conductivity of the output stream may be used to estimate a total number of ions present in the stream at any point in time. Thus, if, for example, the calcium in the received output stream from the DLE column 202 triples and the magnesium doubles, and the chloride also doubles, then the electrical conductivity of the stream will rise.

In response to detecting that the electrical conductivity has increased, it may be assumed that the DLE column 202 is not rejecting as many impurities. Thus, for example, in response to detecting double the impurities coming into the nanofiltration system 210, the controller 212 of apparatus 200 can increase the flux rate and immediately acidify to remove impurities quicker. The apparatus 200 is thus able to make an online immediate change to the nanofiltration operation, and thus prevent scaling of the nanofilters 214, 216. Moreover, the apparatus 200 may reduce or prevent the loss of lithium to the ion streams 218, 220 and also reduce or prevent iron passage that may damage or destroy one or more downstream aspects of the apparatus 200.

FIG. 3 is a schematic diagram depicting an example nanofiltration control schema 300, according to an embodiment. In various embodiments, the nanofiltration control schema 300 can be used in the apparatus 200 for the removal of ions from a brine stream and implemented via a controller, such as the controller 212.

The nanofiltration control schema 300 includes a nanofilter 302 that receives a nanofiltration feed 304 and produces a permeate 306 and concentrate 308. For example, the nanofiltration feed 304 may be received from a DLE unit, such as DLE column 202 of FIG. 2. The permeate 306 may include water and other solvents that are able to pass through the membranes of the nanofilter 302. The concentrate 308 may include lithium among other ions, such as calcium, magnesium, etc.

The nanofiltration control schema 300 includes a feed valve 310 coupled to a line between the received nanofiltration feed 304 and the nanofilter 302. The feed valve 310 may be used to generally control pressure at the nanofilter 302 by regulating the flow of the nanofiltration feed 304. The nanofiltration control schema 300 also includes an electrical conductivity (EC) meter 312 coupled to the line between the feed valve 310 and the nanofilter 302. The EC meter 312 measures the electrical conductivity of the nanofiltration feed 304 coming from the feed valve 310.

The nanofiltration control schema 300 further includes a pH valve 314 that is fluidically coupled via a line to the line from the nanofiltration feed 304 and a pH adjuster 316. The pH adjuster 316 can be any suitable device for adjusting the pH of a brine. In various examples, the pH adjuster 316 can be an acidic tank inlet that lowers the pH or a caustic tank inlet that raises the pH, or both. For example, the pH adjuster 316 may be a tank of hydrochloric acid, or any other suitable acid. In some examples, the pH adjuster 316 may be a tank of sodium hydroxide, or any other suitable caustic. The pH valve 314 may thus be used to control how much acid or caustic flows in from the pH adjuster 316 into the nanofiltration feed 304. In various embodiments, any number of pH valves 314 coupled to any number of pH adjusters 316 may be used to adjust the pH of the nanofiltration feed 304 before the feed enters the feed valve 310. The pH may be adjusted in response to detecting a change in the electrical conductivity of the nanofiltration feed 304 at the EC meter 312. As one example, if a slug of high contaminant feed goes through the DLE and into the nanofiltration feed 304, a higher reading may be measured on the feed side at the EC meter 312. In this example, the nanofilter 302 may be run in a more acidic environment by adjusting the pH valve 314. For example, a pH valve 314 connected to an acidic tank may be opened to decrease the pH of the nanofiltration feed 304 and thus allow for more divalent removal. Additionally, in some embodiments, the nanofilter 302 can operate at a higher flux, which may include closing the concentrate valve some amount to get faster flow on the permeate side. In some embodiments, a variable flow device (VFD) is used to pen the valve until a specified flow rate is met. For example, in such embodiments, the valve is designed for a range of flow rates to ensure the VFD can control to the right flow.

The nanofiltration control schema 300 also further includes a concentrate valve 318 fluidically coupled to the nanofilter 302 and a pressure gauge 320. The concentrate valve 318 can be used to control how much of the nanofiltration feed 304 flows to the permeate 306 versus the concentrate 308. The concentrate valve 316 can be used to control flow in this way because the nanofiltration feed 304 and the concentrate 308 are at very high pressures while the permeate 306 may be at an atmospheric pressure. Thus, if the concentrate valve 318 closes, then the pressure drop may increase and more of the flow of the nanofiltration feed 304 may flow to the permeate 306 side. In this manner, the ratio of the flow between the permeate 306 and the concentrate 308 can be controlled. In some embodiments, the concentrate valve 318 includes a VFD that opens the valve until a target flow rate is reached. The pressure gauge 320 measures the pressure at the concentrate side, and thus enables the determination of the pressure drop between the feed and concentrate side. For example, the filter 302 may have a maximum allowed pressure drop to avoid the membrane shattering. Thus, the pressure gauge 320 is used to avoid such a pressure drop. In addition, in various embodiments, the pressure gauge 320 is used develop a pressure versus flow curve to better control the pump inlet pressure. Moreover, in some embodiments, the pressure gauge 320 is used to detected that the nanofilter 302 has become plugged. For example, the pressure would drop as flow would have a harder time going through a plugged nanofilter 302, with variations in the flow rate.

In various embodiments, the concentrate valve 318 can be adjusted based on the pressure drop measured by pressure gauge 320. For example, in response to detecting that the pressure drop at the pressure gauge 320 exceeds a threshold, then the concentrate valve 318 may be closed until the threshold is no longer exceeded. For example, the percent open (% OP) on the concentrate valve can be increased in response to detecting that the pressure drop exceeds the threshold.

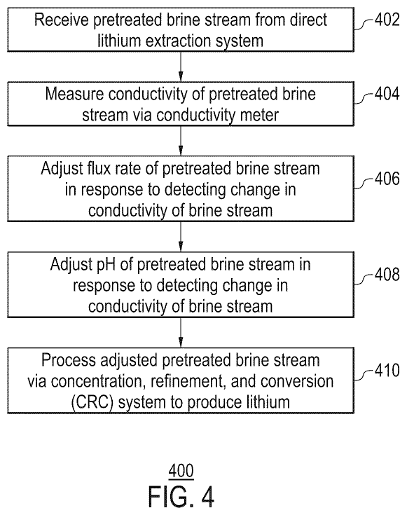

FIG. 4 is a process flow diagram of a method 400 for filtering ions from a brine stream. In various examples, the method 400 may be implemented using the apparatus 200 of FIG. 2 and in the apparatus 100.

At block 402, a pretreated brine stream is received from a direct lithium extraction system. In various embodiments, the pretreated brine stream is a brine stream that contains a higher concentration of lithium ions.

At block 404, a conductivity of the pretreated brine stream is measured via a conductivity meter. In various embodiments, the conductivity meter measures an approximated total number of ions present in the pretreated brine stream.

At block 406, a flux rate of the pretreated brine stream is adjusted in response to detecting a change in the conductivity of the stream. For example, the flux rate may be changed in response to detecting a change that exceeds a threshold. In various embodiments, the flux rate is changed using a feed valve to adjust the flow rate of the incoming pretreated brine stream.

At block 408, a pH of the pretreated brine stream is adjusted in response to detecting a change in the conductivity of the stream. For example, the pH of the pretreated brine stream may be adjusted by adding an acid to the pretreated brine stream. In various embodiments, the acid is hydrochloric acid or sulfuric acid. In some embodiments, the pH of the pretreated brine stream is adjusted by adding a base to the pretreated brine stream. For example, the base may be a caustic such as sodium hydroxide, or any other suitable base. In various embodiments, the pH is adjusted using a pH valve that is fluidically coupled to a pH adjuster and a feed line for the pretreated brine.

At block 410, the adjusted pretreated brine stream is processed via a concentration, refinement, and conversion (CRC) system to produce lithium. In various embodiments, the CRC system includes a nanofiltration system. The nanofiltration system may include any number of nanofilters. For example, in some embodiment, the nanofilters are configured to remove specific ions, such as magnesium ions, calcium ions, among other ions. In some embodiments, a ratio of permeate flow output to concentrate flow output of the nanofilters is adjusted. For example, the ratio can be adjusted using a concentrate valve.

In one or more embodiments, the present techniques may be susceptible to various modifications and alternative forms, such as the following embodiments as noted in paragraphs 1 to 25:

1. An apparatus for brine filtration includes a conductivity meter to receive a pretreated brine stream and measure a conductivity of the pretreated brine stream. The apparatus includes a controller to adjust a flux rate of the pretreated brine stream in response to detecting a change in the conductivity of the pretreated brine stream.

2. The apparatus of paragraph 1, where the pretreated brine stream is a stream output from a direct lithium extraction (DLE) system.

3. The apparatus of any of paragraphs 1-2, where the change in the conductivity of the pretreated brine stream exceeds a threshold.

4. The apparatus of any of paragraphs 1-3, where the controller is to adjust a pH of the pretreated brine stream in response to detecting the change in the conductivity of the pretreated brine stream.

5. The apparatus of paragraph 4, where the pH is adjusted by adding an acid to the pretreated brine stream.

6. The apparatus of any of paragraphs 1-5, including a nanofilter to process the pretreated brine stream at the adjusted flux rate.

7. The apparatus of paragraph 6, where the nanofilter is configured to remove calcium ions from the pretreated brine stream.

8. The apparatus of any of paragraphs 6-7, where the nanofilter is configured to remove magnesium ions from the pretreated brine stream.

9. The apparatus of any of paragraphs 1-8, including a feed valve controllable by the controller to adjust a flow rate of the pretreated brine stream.

10. The apparatus of any of paragraphs 1-9, including a pH valve coupled to a pH adjuster and a nanofiltration feed line, where the controller is to control the pH valve to adjust the pH of a nanofiltration feed in response to detecting the change in conductivity.

11. The apparatus of any of paragraphs 1-10, including a concentrate valve that is controllable by the controller to adjust a ratio of permeate to concentrate generated by a nanofilter.

12. The apparatus of any of paragraphs 1-11, including a concentration, refinement, and conversion (CRC) system to process the pretreated brine stream at the adjusted flux rate to produce lithium.

13. The apparatus of any of paragraphs 1-12, including a pressure gauge to measure a pressure drop between feed inlet pressure and a concentrate pressure.

14. A method of filtering a brine composition includes receiving a pretreated brine stream. The method includes calculating, via a conductivity meter, a conductivity of the pretreated brine stream. The method further includes, in response to detecting a change in the conductivity of the pretreated brine stream, adjusting a flux rate of the pretreated brine stream.

15. The method of paragraph 14, where the pretreated brine stream is pretreated using a direct lithium extraction system.

16. The method of any of paragraphs 14-15, including adjusting a pH of the pretreated brine stream in response to detecting the change in the conductivity of the pretreated brine stream.

17. The method of paragraph 16, where adjusting the pH includes adding an acid to the pretreated brine stream.

18. The method of any of paragraphs 14-17, where the change in the conductivity includes a change that exceeds a predetermined threshold.

19. The method of any of paragraphs 14-19, including processing the pretreated brine stream at the adjusted flux rate via a concentration, refinement, and conversion (CRC) system to produce lithium.

20. The method of paragraph 19, where processing the pretreated brine stream includes filtering, via a nanofilter, calcium ions from the pretreated brine stream at the adjusted flux rate.

21. The method of any of paragraphs 19 and 20, where processing the pretreated brine stream includes filtering, via a nanofilter, magnesium ions from the pretreated brine stream at the adjusted flux rate.

22. The method of any of paragraphs 19-21, where processing the pretreated brine stream includes dewatering the pretreated brine stream after filtering the pretreated brine stream.

23. The method of any of paragraphs 19-22, where processing the pretreated brine stream includes converting the pretreated brine stream into lithium carbonate via a crystallizer.

24. The method of any of paragraphs 19-23, where processing the pretreated brine stream includes filtering ions from the pretreated brine stream using a plurality of nanofilters.

25. The method of any of paragraphs 16-24, including filtering, via a nanofilter, the pretreated brine stream at the adjusted flux rate, where a concentrate valve is used to modify a ratio of a permeate stream to concentrate stream from the nanofilter.

While the present techniques may be susceptible to various modifications and alternative forms, the embodiments discussed above have been shown only by way of example. However, it should again be understood that the techniques is not intended to be limited to the particular embodiments disclosed herein. Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated. All numerical values within the detailed description herein are modified by “about” the indicated value, and take into account experimental error and variations that would be expected by a person having ordinary skill in the art. Indeed, the present techniques include all alternatives, modifications, and equivalents falling within the true spirit and scope of the appended claims.

What is claimed is:

1. An apparatus for brine filtration, comprising:
a conductivity meter to receive a pretreated brine stream and measure a conductivity of the pretreated brine stream; and
a controller to adjust a flux rate of the pretreated brine stream in response to detecting a change in the conductivity of the pretreated brine stream.

2. The apparatus of claim 1, wherein the pretreated brine stream is a stream output from a direct lithium extraction (DLE) system.

3. The apparatus of claim 1, wherein the change in the conductivity of the pretreated brine stream exceeds a threshold.

4. The apparatus of claim 1, wherein the controller is to adjust a pH of the pretreated brine stream in response to detecting the change in the conductivity of the pretreated brine stream.

5. The apparatus of claim 4, wherein the pH is adjusted by adding an acid to the pretreated brine stream.

6. The apparatus of claim 1, comprising a nanofilter to process the pretreated brine stream at the adjusted flux rate.

7. The apparatus of claim 6, wherein the nanofilter is configured to remove calcium ions from the pretreated brine stream.

8. The apparatus of claim 6, wherein the nanofilter is configured to remove magnesium ions from the pretreated brine stream.

9. The apparatus of claim 1, comprising a feed valve controllable by the controller to adjust a flow rate of the pretreated brine stream.

10. The apparatus of claim 1, comprising a pH valve coupled to a pH adjuster and a nanofiltration feed line, wherein the controller is to control the pH valve to adjust the pH of a nanofiltration feed in response to detecting the change in conductivity.

11. The apparatus of claim 1, comprising a concentrate valve that is controllable by the controller to adjust a ratio of permeate to concentrate generated by a nanofilter.

12. The apparatus of claim 1, comprising a concentration, refinement, and conversion (CRC) system to process the pretreated brine stream at the adjusted flux rate to produce lithium.

13. The apparatus of claim 1, comprising a pressure gauge to measure a pressure drop between feed inlet pressure and a concentrate pressure.

14. A method of filtering a brine composition, the method comprising:
receiving a pretreated brine stream;
calculating, via a conductivity meter, a conductivity of the pretreated brine stream; and
in response to detecting a change in the conductivity of the pretreated brine stream, adjusting a flux rate of the pretreated brine stream.

15. The method of claim 14, wherein the pretreated brine stream is pretreated using a direct lithium extraction system.

16. The method of claim 14, comprising adjusting a pH of the pretreated brine stream in response to detecting the change in the conductivity of the pretreated brine stream.

17. The method of claim 16, wherein adjusting the pH comprises adding an acid to the pretreated brine stream.

18. The method of claim 14, wherein the change in the conductivity comprises a change that exceeds a predetermined threshold.

19. The method of claim 14, comprising processing the pretreated brine stream at the adjusted flux rate via a concentration, refinement, and conversion (CRC) system to produce lithium.

20. The method of claim 19, wherein processing the pretreated brine stream comprises filtering, via a nanofilter, calcium ions from the pretreated brine stream at the adjusted flux rate.

21. The method of claim 19, wherein processing the pretreated brine stream comprises filtering, via a nanofilter, magnesium ions from the pretreated brine stream at the adjusted flux rate.

22. The method of claim 19, wherein processing the pretreated brine stream comprises dewatering the pretreated brine stream after filtering the pretreated brine stream.

23. The method of claim 19, wherein processing the pretreated brine stream comprises converting the pretreated brine stream into lithium carbonate via a crystallizer.

24. The method of claim 19, wherein processing the pretreated brine stream comprises filtering ions from the pretreated brine stream using a plurality of nanofilters.

25. The method of claim 16, comprising filtering, via a nanofilter, the pretreated brine stream at the adjusted flux rate, wherein a concentrate valve is used to modify a ratio of a permeate stream to concentrate stream from the nanofilter.
